(19) United States
(12) Patent Application Publication
(10) Pub. No.: US 2026/0174279 A1
(43) Pub. Date: Jun. 25, 2026

(54) PAN WITH REINFORCED RIM

(71) Applicant: HFA, INC., Wheeling, IL (US)

(72) Inventors: Norton Sarnoff, Boca Raton, IL (US); Raj Patel, Kildeer, IL (US)

(73) Assignee: HFA, INC., Wheeling, IL (US)

(21) Appl. No.: 19/202,822

(22) Filed: May 8, 2025

Related U.S. Application Data
(63) Continuation-in-part of application No. 29/979,753, filed on Dec. 20, 2024.
(63) Continuation-in-part of application No. 29/987,182, filed on Jan. 22, 2025.
(63) Continuation-in-part of application No. 29/987,561, filed on Jan. 24, 2025.
(63) Continuation-in-part of application No. 29/987,562, filed on Jan. 24, 2025.

(51) Int. Cl. A47J 36/02

(52) U.S. Cl. CPC A47J 36/022

(57) ABSTRACT

An improved disposable aluminum pan with a reinforced rim. The rim defined as a first terminal edge connects an upper edge of the sidewall to a first upwardly extending surface, the first upwardly extending surface connects to a second upwardly extending surface, that extends laterally at an angle different from the first upwardly extending surface, the second upwardly extending surface connects to a first outwardly extending surface, the first outwardly extending surface connects to a first downwardly curved surface that further curves outwardly from the first outwardly extending surface, the first downwardly curved surface connects to a second outwardly extending surface, the second outwardly extending surface further connects to a second downwardly curved surface, and the second downwardly curved surface terminates to the rolled bead.

### CROSS REFERENCE TO RELATED APPLICATIONS

The present invention in a Continuation In Part of U.S. application Ser. No. 29/979,753 filed Dec. 20, 2024; Ser. No. 29/987,182 filed Jan. 22, 2025; Ser. No. 29/987,561 filed Jan. 24, 2025; and Ser. No. 29/987,562 filed Jan. 24, 2025; all of which are hereby incorporated by reference in their entirety.

### FIELD OF THE INVENTION

The present invention relates to the disposable aluminum pans and similar items, and more particularly, the present invention is directed to a disposable aluminum pans with a reinforced rim.

### BACKGROUND OF THE INVENTION

Disposable pans are typically foil pans used by consumers to heat food, keep food warm, store food in refrigerators and then reheated later. Prior art pan as shown in FIGS. 1 and 2, show a pan 10 with a bottom 12 and a continuous side wall 14 extending up to a terminal edge 16. A rim 18 extends from the terminal edge and ends in a rolled bead 20. The rim 18 extends outwardly from the terminal edge and can extend at an angle or straight. The rim 18 is also usually flat but in some instances can include an indented handle on the short ends to help users grip the pan.

The problem with the prior art rims 18 is that they can be a weak point in the pan which could cause the pan to bend or break. As such, there is a desire to fortify the rim or reinforce the rim to avoid these and other issues in the prior art.

### SUMMARY OF THE INVENTION

In accordance with one embodiment of the present invention, there is provided an improved disposable aluminum pan with a reinforced rim. The pan is defined as having a sidewall extending upwardly from a bottom base and terminating into an outstanding rim. The rim further terminates into a rolled bead. The rim is configured as a reinforced rim defined by having: (a) a first terminal edge connects an upper edge of the sidewall to a first upwardly extending surface, (b) the first upwardly extending surface connects to a second upwardly extending surface, that extends laterally at an angle different from the first upwardly extending surface, (c) the second upwardly extending surface connects to a first outwardly extending surface, (d) the first outwardly extending surface connects to a first downwardly curved surface that further curves outwardly from the first outwardly extending surface, (e) the first downwardly curved surface connects to a second outwardly extending surface, (f) the second outwardly extending surface further connects to a second downwardly curved surface, and (g) the second downwardly curved surface terminates to the rolled bead.

Numerous other advantages and features of the invention will become readily apparent from the following detailed description of the invention and the embodiments thereof, from the claims, and from the accompanying drawings.

### BRIEF DESCRIPTION OF THE DRAWINGS

A fuller understanding of the foregoing may be had by reference to the accompanying drawings, wherein:

FIG. 1 is a Prior Art pan;

FIG. 2 is a exploded portional view of the Prior Art pan from FIG. 1;

FIG. 3A is a pan with a reinforced rim in accordance with an embodiment of the present invention;

FIG. 3B is a enlarged section from FIG. 3A;

FIG. 4 is a perspective view of the pan from FIG. 3A;

FIG. 5 is an overlay of material used for a prior art pan and pan with reinforced rim; and

FIG. 6 is another embodiment of a pan with a reinforced rim.

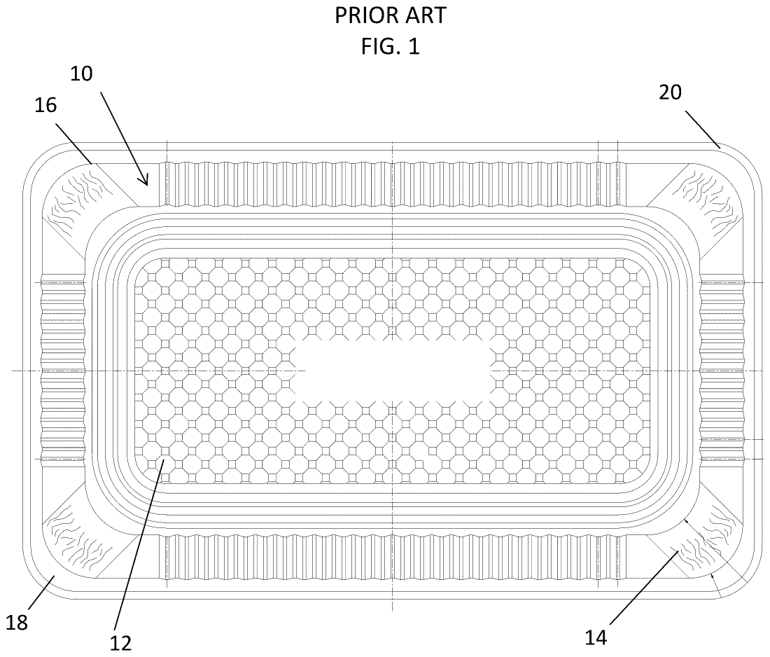

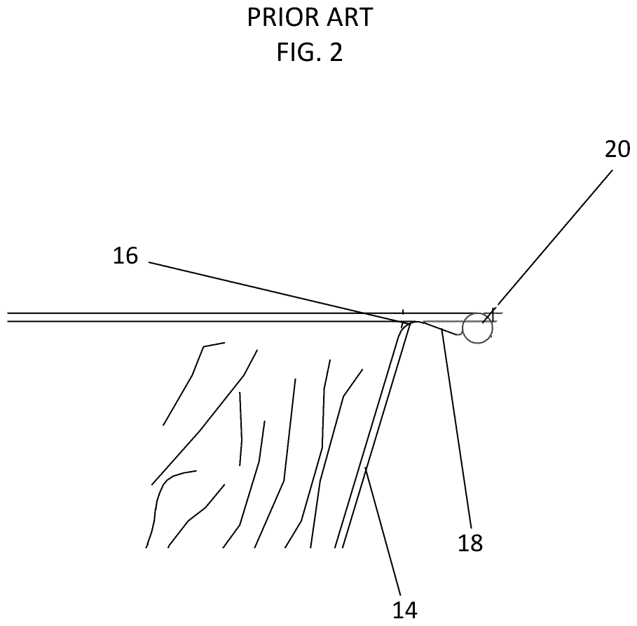

### DETAILED DESCRIPTION OF THE EMBODIMENTS

While the invention is susceptible to embodiments in many different forms, there are shown in the drawings and will be described herein, in detail, the preferred embodiments of the present invention. It should be understood, however, that the present disclosure is to be considered an exemplification of the principles of the invention and is not intended to limit the spirit or scope of the invention and/or claims of the embodiments illustrated.

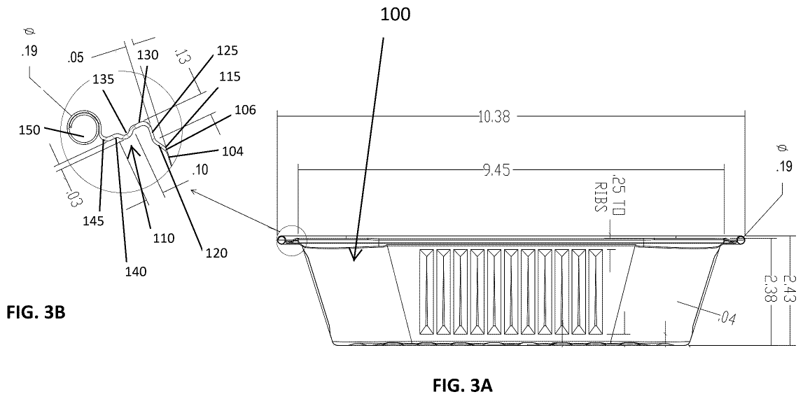

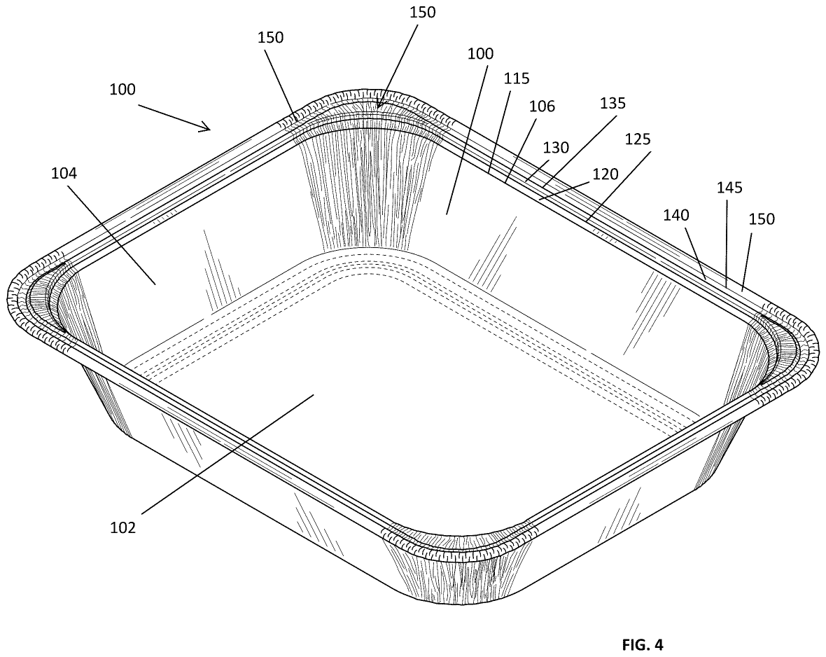

With reference to FIGS. 3A-4 , having outlined the problems in the prior art, the present invention is thus directed to a new and novel pan 100 with a reinforced rim 110. The new is created similarly to the prior art pan, in that the new pan 100 includes a bottom base 102 that terminates to an upwardly extending continuous sidewall 104. Surrounding a top portion of the sidewall 104 is an outstanding reinforced rim 110 that terminates to a rolled bead 150. The pan is typically made of stamped aluminum.

The improvement in the reinforced rim 110 is defined by the following characteristics in its formation. The reinforced rim 110 is defined in having: (i) a first terminal edge 115 connects an upper edge 106 of the sidewall 104 to a first upwardly extending surface 120, (ii) the first upwardly extending surface 120 connects to a second upwardly extending surface 125, that extends laterally at an angle different from the first upwardly extending surface 120, (iii) the second upwardly extending surface connects to a first outwardly extending surface 130, (iv) the first outwardly extending surface 130 connects to a first downwardly curved surface 135 that further curves outwardly from the first outwardly extending surface 130, (v) the first downwardly curved surface 135 connects to a second outwardly extending surface 140, (vi) the second outwardly extending surface 140 further connects to a second downwardly curved surface 145, and (vii) the second downwardly curved surface 145 terminates to the rolled bead 150.

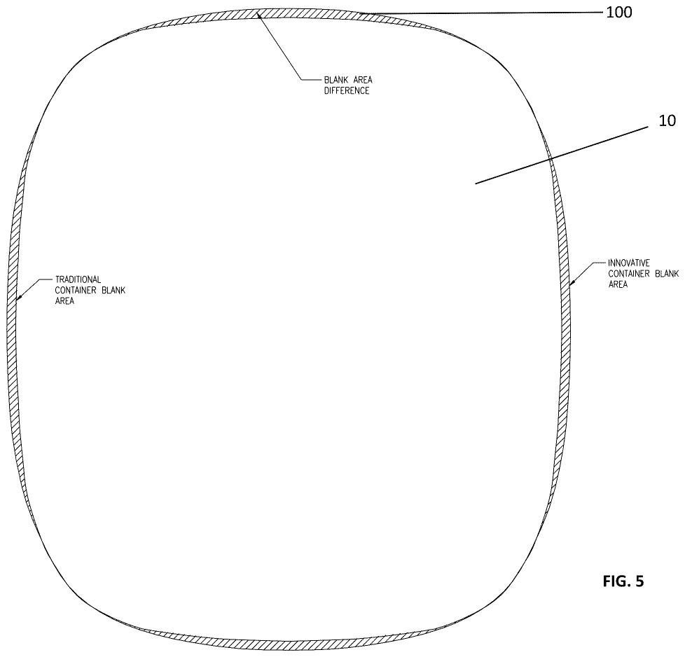

Referring now to FIG. 5, there is shown an overlay of the material used from a prior art pan 10 and the pan 100 with a reinforced rim 110. As illustrated, the pan 100 with a reinforced rim 110 uses more aluminum which increases costs. However, the reinforced rim 110 provides advantages over the cost.

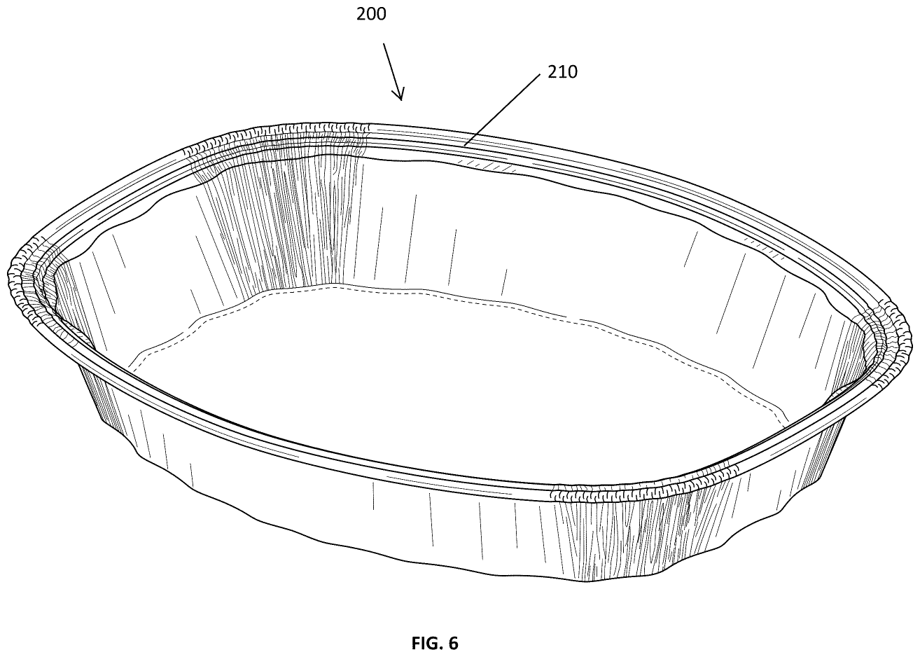

Referring now to FIG. 6, there is shown another pan 200 with a reinforced rim 210 with a different overall shape from the pan 100 shown in FIG. 3.

From the foregoing and as mentioned above, it will be observed that numerous variations and modifications may be effected without departing from the spirit and scope of the novel concept of the invention. It is to be understood that no limitation with respect to the specific methods and apparatus illustrated herein is intended or should be inferred. It is, of course, intended to cover by the appended claims all such modifications as fall within the scope of the claims.

We claim:

1. An improved disposable aluminum pan with a reinforced rim, comprising:
a sidewall extending upwardly from a bottom base and terminating into an outstanding rim, the rim further terminates into a rolled bead, and wherein the rim is configured as a reinforced rim defined by having:
a first terminal edge connects an upper edge of the sidewall to a first upwardly extending surface,
the first upwardly extending surface connects to a second upwardly extending surface, that extends laterally at an angle different from the first upwardly extending surface,
the second upwardly extending surface connects to a first outwardly extending surface,
the first outwardly extending surface connects to a first downwardly curved surface that further curves outwardly from the first outwardly extending surface,
the first downwardly curved surface connects to a second outwardly extending surface,
the second outwardly extending surface further connects to a second downwardly curved surface, and
the second downwardly curved surface terminates to the rolled bead.

2. An improved disposable aluminum pan with a reinforced rim, wherein the pan is defined as having a sidewall extending upwardly from a bottom base and terminating into an outstanding rim, the rim further terminates into a rolled bead, and wherein the rim is configured as a reinforced rim comprising:
a first terminal edge connects an upper edge of the sidewall to a first upwardly extending surface,
the first upwardly extending surface connects to a second upwardly extending surface, that extends laterally at an angle different from the first upwardly extending surface,
the second upwardly extending surface connects to a first outwardly extending surface,
the first outwardly extending surface connects to a first downwardly curved surface that further curves outwardly from the first outwardly extending surface,
the first downwardly curved surface connects to a second outwardly extending surface,
the second outwardly extending surface further connects to a second downwardly curved surface, and
the second downwardly curved surface terminates to the rolled bead.
